(19) United States
(12) Patent Application Publication
(10) Pub. No.: US 2018/0057616 A1
(43) Pub. Date: Mar. 1, 2018

(54) REDUCING RESIDUAL MONOMER CONTENT IN COPOLYMERS OF STYRENE AND VINYLPYRIDINE

(71) Applicant: Novus International, Inc, St. Charles, MO (US)

(72) Inventors: Xiaojun Wang, St. Charles, MO (US); Graciela B. Arhancet, St. Charles, MO (US); Richard Vonder Embse, St. Charles, MO (US); John Hume, St. Charles, MO (US)

(21) Appl. No.: 15/689,151

(22) Filed: Aug. 29, 2017

Related U.S. Application Data
(60) Provisional application No. 62/381,425, filed on Aug. 30, 2016.
(60) Provisional application No. 62/443,544, filed on Jan. 6, 2017.

(51) Int. Cl. C08F 6/00; C08F 212/08; C08F 226/06

(52) U.S. Cl. CPC C08F 6/003; C08F 226/06; C08F 212/08

(57) ABSTRACT

Copolymers of styrene and vinylpyridine having residual monomer levels of less than about 1000 parts per billion and processes for preparing said copolymers.

### CROSS-REFERENCE TO RELATED APPLICATIONS

This application claims the priority of U.S. Provisional Application Ser. No. 62/381,425, filed Aug. 30, 2016, and U.S. Provisional Application Ser. No. 62/443,544, filed Jan. 6, 2017, each of which is hereby incorporated by reference in its entirety.

### FIELD

The present disclosure generally relates to copolymers of styrene and vinylpryridine having low levels of residual monomers and processes for preparing said copolymers.

### BACKGROUND

Most polymers are contaminated with unreacted monomers because polymerization reactions rarely proceed to completion. Besides affecting polymer properties, the residual monomers can have undesirable effects on workers during production of the polymers or during the production of products comprising the polymers. Additionally, the residual monomers can affect the downstream consumers of said products. Thus, there is a need for polymers, and especially for polymers used in food applications, that have no or very low levels of residual monomers. Accordingly, industrial-scale processes are needed to prepare polymers having reduced levels of residual monomers.

### SUMMARY

Among the various aspects of the present disclosure encompasses a copolymer of styrene and a vinylpyridine that has a residual monomer content of less than about 1000 parts per billion (ppb), wherein the copolymer of styrene and vinylpyridine is produced in a batch of at least about one kilogram.

Another aspect of the present disclosure encompasses a process for preparing a copolymer of styrene and a vinylpyridine having a residual monomer content of less than about 1000 parts per billion (ppb). The process comprises (a) mixing styrene and vinylpyridine monomers, an aqueous solvent, an alkalizing agent, and a surfactant to form an emulsion; (b) heating the emulsion at a temperature of about 50° C. to about 60° C. in the presence of a polymerization initiator to form the styrene-vinylpyridine copolymer; (c) contacting the emulsion from step (b) with sodium hydrogen phosphate to form a coagulated copolymer; and (d) isolating and drying the coagulated copolymer at a temperature of at least about 60° C. under reduced pressure or an inert atmosphere to produce the copolymer of styrene and a vinylpyridine in which the residual monomer content is less than about 1000 ppb.

A further aspect of the present disclosure provides a process for preparing a copolymer of styrene and a vinylpyridine having a residual monomer content of less than about 1000 parts per billion (ppb). The process comprises (a) adding styrene and vinylpyridine monomers to a mixture comprising an aqueous solvent, an alkalizing agent, a surfactant, and a suspending agent to form a suspension; (b) heating the suspension at a temperature of about 50° C. to about 80° C. in the presence of a free radical initiator to form the styrene-vinylpyridine copolymer; and (c) isolating and drying the styrene-vinylpyridine copolymer at a temperature of at least about 60° C. under reduced pressure or an inert atmosphere to produce the copolymer of styrene and a vinylpyridine in which the residual monomer content is less than about 1000 ppb.

Other features and iterations of the disclosure are described in more detail below.

### DETAILED DESCRIPTION

Provided herein are processes for preparing copolymers of styrene and vinylpyridine in which the residual content of styrene and vinylpyridine monomers is reduced to less than 1000 parts per billion (ppb). The processes disclosed herein have high conversion rates such that amount of unreacted monomers is minimized. The processes also comprise a drying step, which further reduces the residual monomer content of the copolymers. Also provided are copolymers of styrene and vinylpyridine in which the residual monomer content is less than about 1000 ppb, and wherein the copolymer of styrene and a vinylpyridine is produced in a batch of at least about one kilogram.

(I) Process for Preparing Copolymers of Styrene and Vinylpyridine with Reduced Residual Monomer Content

The present disclosure provides processes for preparing copolymers of styrene and vinylpyridine in which the residual monomer content is less than about 1000 ppb. The copolymers with reduced monomer content also have inherent viscosities ranging from about 1.0 to about 1.6 dL/g, wherein inherent viscosity is measure in a 0.25% solution of the copolymer at room temperature.

In general, the processes disclosed herein are industrial processes in which the copolymer is produced in a batch of at least 1 kilograms (kg). In some embodiments, the copolymer is produced in a batch of at least 10 kg. In other embodiments, the copolymer is produced in a batch of at least 100 kg. In still other embodiments, the copolymer is produced in a batch of at least 1000 kg (or 1 metric ton).

The processes disclosed herein comprise forming a copolymer by polymerizing styrene and vinylpyridine monomers, and drying the copolymer at a temperature of at least about 60° C. under reduced pressure or under an inert atmosphere to reduce the monomer levels.

(a) Monomers

The copolymer is prepared by polymerizing styrene and a vinylpyridine. The vinylpyridine may be 2-vinylpyridine, 3-vinylpyridine, 4-vinylpyridine, 2-methyl-5-vinylpyridine, 5-ethyl-2-vinylpyridine, or mixtures thereof. In specific embodiments, the vinylpyridine may be 2-vinylpyridine. Thus, the copolymer maybe poly(2-vinylpyridine-co-styrene).

The weight ratio of styrene to vinylpyridine may range from about 10:90 to about 90:10. In various embodiments, the weight ratio of styrene to vinylpyridine may be about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, about 90:10, or ratios between those listed. In certain embodiments, the weight ratio of styrene to vinylpyridine may be about 20:80, about 25:75, about 30:70, about 35:65, or about 40:60. In specific embodiments, the weight ratio of styrene to vinylpyridine may be about 30:70.

In some embodiments, the styrene and vinylpyridine monomers may be combined and washed to remove stabilizer(s). For example, the monomers may be washed with about 0.5 volumes to about 0.7 volumes of an alkaline solution. In some embodiments, the monomer may be washed with about 0.6 volumes of the alkaline solution. The alkaline solution generally has a pH value from about 13 to about 14. The alkaline solution may comprise hydroxides of alkali metals and alkaline earth metals (such as, for example, sodium hydroxide, potassium hydroxide, calcium hydroxide, and the like), as well as group 1 salts of carbanions, amides, and hydrides (such as, for example, butyl lithium, sodium amide, sodium hydride, and the like). In certain embodiments, the alkaline solution may be a sodium hydroxide solution, for example, a 5% sodium hydroxide solution. The washing with the alkaline solution may proceed at a temperature from about 20° C. to about 65° C. In some embodiments, the washing may occur at about room temperature. In other embodiments, the washing may occur at an elevated temperature, for example, at about 50° C. to about 60° C. or at 60° C. to about 65° C. The washing with the alkaline solution may be performed once, twice, or more than two times.

After washing in the alkaline solution, the monomers and residual alkaline solution are generally rinsed with water. In various embodiments, the monomers may be rinsed with about 1 volume to about 2 volumes of water, and the rinsing with water may be repeated two times, three times, or more than three times. The rinsing with water may proceed at a temperature from about 20° C. to about 65° C.

In other embodiments, the styrene and vinylpyridine monomers are not washed to remove stabilizer(s) and polymerization reaction is conducted in the presence of the stabilizer(s).

(b) Forming the Copolymer

The styrene and vinylpyridine monomers are polymerized under suitable conditions to form the copolymer of styrene and vinylpyridine. The polymerization reaction may be solution polymerization, suspension polymerization, emulsion polymerization, radical polymerization, ionic polymerization, bulk polymerization, step-reaction polymerization, complex coordination polymerization, and so forth.

(i) Emulsion Polymerization

In some embodiments, the copolymer is prepared by emulsion polymerization. In emulsion polymerization, droplets of monomer are emulsified in a continuous aqueous phase. Emulsion polymerization comprises forming a reaction mixture comprising the monomers, heating the emulsion mixture in the presence of a polymerization initiator to form the copolymer, coagulating the copolymer by contact with a coagulation initiator, and isolating the copolymer.

Forming Reaction Mixture.

For this, a reaction mixture is prepared by combining the monomers, an aqueous solvent, an alkalizing agent, and a surfactant (i.e., the emulsifier). The reaction mixture forms an emulsion.

Suitable aqueous solvents include water, alcohols (e.g., methanol, ethanol, and the like). In exemplary embodiments, the solvent may be water. The amount of solvent included in the reaction mixture can and will vary. In general, the volume to mass ratio of solvent to monomers may range from about 3:1 to about 6:1. In various embodiments, the volume to mass ratio of solvent to monomers may range from about 3:1 to about 4:1, from about 4:1 to about 5:1, or from about 5:1 to about 6:1. In specific embodiments, the volume to mass ratio of solvent to monomers may be about 3.3:1.

An alkalizing agent is added to the reaction mixture such that the pH of the mixture ranges from about 10 to about 14, and the vinylpyridine is insoluble. In specific embodiments, the pH of the mixture may range from about 11 to about 13. Suitable alkalizing agents include hydroxide salts (such as, for example, NaOH, KOH, mixtures thereof, and the like), borate salts (such as, for example, Na₃BO₃), di- and tri-basic phosphate salts (such as, for example, Na₂HPO₄ and Na₃PO₄), bicarbonate salts (such as, for example, NaHCO₃, KHCO₃, mixtures thereof, and the like), and carbonate salts (such as, for example, Na₂CO₃, K₂CO₃, mixtures thereof, and the like). In specific embodiments, the alkalizing agent may be sodium hydroxide or potassium hydroxide. In embodiments in which the alkalizing agent is a hydroxide salt, the weight ratio of the alkalizing agent to the solvent may range from about 0.25 wt % to about 0.75 wt %, from about 0.4 wt % to about 0.6 wt, or the weight ratio may be about 0.5 wt %.

The reaction mixture further comprises a surfactant. Suitable surfactants include salts of oleic acid and salts of lauric acid. In some embodiments the surfactant may be sodium oleate, potassium oleate, sodium laurate, potassium laurate, sodium oleyl sulfate, potassium oleyl sulfate, sodium lauryl sulfate, potassium lauryl sulfate, sodium oleyl phosphate, potassium oleyl phosphate, sodium lauryl phosphate, or potassium lauryl phosphate. In specific embodiments, the surfactant may be sodium oleate or sodium laurate. In some embodiments, the surfactant may be formed in situ by adding oleic acid or lauric acid to a reaction mixture that contains a sodium salt (or a potassium salt). The amount of surfactant added to the mixture may range from about 2.5 wt % to about 4.0 wt %. In some embodiments, the weight ratio of surfactant to monomers may range from about 2.8 wt % to about 3.4 wt %, from about 3.0 to about 3.2 wt %, or about 3.1 wt %.

Polymerization. The reaction mixture generally is stirred at a rate that is sufficient to maintain the emulsion. The emulsion may be heated to a temperature that ranges from about 30° C. to about 80° C. In some embodiments, the emulsion may be heated to about 50° C. to about 75° C., from about 50° C. to about 70° C., from about 50° C. to about 65° C., or from about 50° C. to about 60° C.

When the temperature reaches about 50° C., a polymerization initiator is added to the emulsion. Suitable polymerization initiators include persulfates (e.g, sodium persulfate, potassium persulfate, ammonium persulfate, hydroxy methanesulfonic acid monosodium salt, and the like), organic peroxides (e.g., benzoyl peroxide, tert-butyl hydroperoxide, and so forth), and azo compounds (e.g., azobisisobutyronitrile and the like). In specific embodiments, the polymerization initiator may be sodium persulfate. The weight ratio of the polymerization initiator to the monomers may range from about 0.5 wt % to about 1.5 wt %. In some embodiments, the weight ratio of the polymerization initiator to the monomers may be about 0.67 wt %. In other embodiments, the weight ratio of the polymerization initiator to the monomers may be about 1.0 wt %. The polymerization initiator may be dissolved in a solvent (e.g., as a 5% solution) and the solution may be added to the emulsion over a period of time. The period of time may encompass about 5 minutes, about 10 minutes, about 30 minutes, about 60 minutes, about 2 hours, or longer than about 2 hours.

In general, the polymerization reaction is conducted at a temperature that ranges from about 50° C. to about 80° C. In some embodiments, the temperature may range from about 50° C. to about 75° C. or from about 50° C. to about 70° C. In other embodiments, the temperature may range from about 50° C. to about 65° C. or from about 50° C. to about 60° C.

The duration of the polymerization reaction may be about 8 hours, about 12 hours, about 18 hours, about 24 hours, about 36 hours, or about 48 hours.

Coagulation. The process further comprises contacting the emulsion comprising the copolymer of styrene and vinylpyridine with a coagulation initiator to effect coagulation of the copolymer. Suitable coagulation initiators include mineral salts (e.g., sodium hydrogen phosphate, sodium chloride, potassium chloride, aluminium sulfate, ferric chloride, calcium chloride, magnesium chloride, and so forth) and acids (e.g., acetic acid, sulfuric acid, hydrochloric acid, and the like). In exemplary embodiments, the coagulation initiator may be sodium hydrogen phosphate.

The amount of coagulation initiator added to the emulsion can and will vary depending, for example, on the identity of the coagulation initiator. In general, the molar ratio of the coagulation initiator to the alkalizing agent added to the emulsion ranges from about 0.1:1 to about 150:1. In various embodiments, the molar ratio of the coagulation initiator to the alkalizing agent may range from about 0.1:1 to about 3:1, from about 3:1 to about 10:1, from about 10:1 to about 30:1, from about 30:1 to about 100:1, or from about 100:1 to about 150:1. In embodiments in which the coagulation initiator is sodium hydrogen phosphate, the molar ratio of the coagulation initiator to the alkalizing agent may range from about 0.5:1 to about 2:1 or from about 0.8:1 to about 1.2:1. In specific embodiments in which the coagulation initiator is sodium hydrogen phosphate, the molar ratio of the coagulation initiator to the alkalizing agent may be about 1:1.

In general, the coagulation initiator is added to the emulsion comprising the copolymer of styrene and vinylpyridine as an aqueous solution. In various embodiments, the amount of aqueous solution comprising the coagulation initiator added to the emulsion may range from about 3 mL to about 30 mL per gram of starting monomer. In certain embodiments, about 5 mL to about 15 mL of the aqueous solution comprising the coagulation initiator may be added to the emulsion. In one embodiment, about 10 mL of the aqueous solution comprising the coagulation initiator may be added to the emulsion.

In general, the emulsion is heated to a temperature ranging from about 25° C. to about 60° C. before the coagulation initiator is added to the emulsion. In some embodiments, the emulsion may be heated to a temperature ranging from about 25° C. to about 45° C., or from about 45° C. to about 60° C. before the coagulation initiator is added. In specific embodiments, the emulsion may be heated to a temperature from about 50° C. to about 55° C. before the coagulation initiator is added. The coagulation process may be allowed to proceed for about 1 minute to about 120 minutes. In some embodiments, the duration may range from about 1 to about 10 minutes, from about 10 minutes to about 30 minutes, from about 30 minutes to about 60 minutes, or from about 60 minutes to about 120 minutes.

Once coagulation of the copolymer is complete, the mixture may be heated to a temperature ranging from about from about 55° C. to about 70° C. for at least one hour. In specific embodiments, the coagulated copolymer mixture may be heated to about 60° C. to about 65° C. for at least about 1 hour, at least about 2 hours, or at least about 3 hours.

Isolation.

The coagulated copolymer may be isolated from the mixture by a suitable collection means. In some embodiments, the coagulated copolymer may be isolated by filtration, e.g., gravity filtration, hot filtration, ambient filtration, cold filtration, vacuum filtration. In other embodiments, the coagulated copolymer may be isolated by centrifugation and decantation. The isolated copolymer may be washed with water one or more times.

(ii) Suspension Polymerization

In other embodiments, the copolymer may be prepared by suspension polymerization. In suspension polymerization, drops of a monomer-containing phase are dispersed in a continuous liquid phase and polymer is produced inside the drops. The polymerization process comprises forming a reaction mixture comprising the monomers, and heating in the presence of a free radical initiator to form copolymer beads, and isolating the copolymer beads.

Forming Reaction Mixture.

The reaction mixture comprises an aqueous phase, an alkalizing agent, a surfactant, a suspending agent, and the monomers.

In general, the aqueous phase comprises on or more water soluble solvents. Suitable solvents include water, alcohols (e.g., methanol, ethanol, and the like). In exemplary embodiments, the solvent may be water. The amount of solvent included in the reaction mixture can and will vary. In general, the volume to mass ratio of solvent to monomers may range from about 1:1 to about 10:1.

Suitable alkalizing agents include hydroxide salts (such as, for example, NaOH, KOH, mixtures thereof, and the like), borate salts (such as, for example, Na₃BO₃), di- and tri-basic phosphate salts (such as, for example, Na₂HPO₄ and Na₃PO₄), bicarbonate salts (such as, for example, NaHCO₃, KHCO₃, mixtures thereof, and the like), and carbonate salts (such as, for example, Na₂CO₃, K₂CO₃, mixtures thereof, and the like). In specific embodiments, the alkalizing agent may be sodium hydroxide or potassium hydroxide. The amount of alkalizing agent added to the reaction mixture can and will vary. In general, the amount is sufficient to adjust the pH of the mixture to 10 to about 14, such that the vinylpyridine is insoluble. In specific embodiments, the pH of the mixture may range from about 11 to about 13.

The reaction mixture further comprises a surfactant, which may stabilize the drops. Suitable surfactants include salts of oleic acid and salts of lauric acid. In some embodiments the surfactant may be sodium oleate, potassium oleate, sodium laurate, potassium laurate, sodium oleyl sulfate, potassium oleyl sulfate, sodium lauryl sulfate, potassium lauryl sulfate, sodium oleyl phosphate, potassium oleyl phosphate, sodium lauryl phosphate, or potassium lauryl phosphate. In specific embodiments, the surfactant may be sodium oleate or sodium laurate. In some embodiments, the surfactant may be formed in situ by adding oleic acid or lauric acid to a reaction mixture that contains a sodium salt (or a potassium salt). The amount of surfactant added to the mixture may range from about 0.1 wt % to about 5.0 wt %.

The reaction mixture also comprises a suspending agent. Suitable suspending agents include naturally-occurring or synthetic water-miscible polymers. Non-limiting examples include carboxymethyl methyl cellulose, carboxymethylcellulose, sodium carboxymethylcellulose, methylcellulose, hydroxyethyl cellulose, microcrystalline cellulose, carbomer, alginates, acacia, tragacanth, xanthan gum, bentonite, carrageenan, gelatin, and so forth. The amount of suspending agent may range from about 0.01% to about 10%. In some embodiments, the amount of suspending agent may range from 0.05% to about 2%.

The styrene and vinylpyridine monomers may be added to the reaction mixture with stirring.

In some embodiments, a plasticizing solvent may be added to the reaction mixture prior to polymerization. Non-limiting examples of suitable plasticizing solvents include toluene, octane, cyclohexane, heptane, benzyl alcohol, and isoamyl alcohol. In general Hansen solubility parameters can help identify additional plasticizing solvent candidate.

Polymerization.

Polymerization is conducted in the presence of a free radical initiator. Suitable free radical initiators include without limit t-butyl peroctoate, t-butyl perbenzoate, benzoyl peroxide, lauryl peroxide, t-butyl peroxybenzoate, and t-butyl hydroperoxide. The amount of free radical initiator can and will vary depending upon the desired molecular weight distribution of the copolymer. For example, higher concentrations of free radical initiator result in more propagating chains and more termination, and thus, a lower polymer molecular weight.

In general, the polymerization reaction is conducted at a temperature that ranges from about 50° C. to about 80° C. In some embodiments, the temperature may range from about 50° C. to about 75° C. or from about 50° C. to about 70° C. In other embodiments, the temperature may range from about 50° C. to about 65° C. or from about 50° C. to about 60° C.

In some embodiments, a plasticizing solvent may be added during polymerization to increase surface area, the thus, drying rate. Adding the plasticizing solvent towards the end of the polymerization reaction or after completion of the polymerization reaction may increase the mobility of the unreacted monomers. Suitable plasticizing solvents are described above.

Isolation.

The copolymer may be isolated from the mixture by a suitable collection means. In some embodiments, the copolymer may be isolated by filtration, e.g., gravity filtration, hot filtration, ambient filtration, cold filtration, vacuum filtration. In other embodiments, the coagulated copolymer may be isolated by centrifugation and decantation. The isolated copolymer may be washed with water one or more times.

(c) Drying the Copolymer

The process further comprises drying the isolated copolymer to reduce residual moisture levels and reduce residual monomer levels. The drying step generally comprises heating the isolated copolymer to a temperature ranging from about 55° C. to about 95° C. under reduced pressure or under an inert atmosphere. In some embodiments, the isolated copolymer may be dried by heating to a temperature ranging from about 60° C. to about 90° C. In specific embodiments, the isolated copolymer may be dried by heating to a temperature ranging from about 70° C. to about 80° C. In embodiments in which the isolated copolymer is dried under reduced pressure, the pressure may range from about 0 inHg (or Pascals, Pa) to about −50 inHg (−1.69×10⁵ Pa). In some embodiments, the pressure may range from about −10 inHg (−3.39×10⁴ Pa) to about −40 inHg (−1.35×10⁵ Pa), from about −15 inHg (−5.08×10⁴ Pa) to about −35 inHg (1.19×10⁵ Pa), or from about −20 inHg (−6.77×10⁴ Pa) to about −30 inHg (−1.02×10⁵ Pa). In specific embodiments, the pressure may range from about −23 inHg (−7.79×10⁴ Pa) to about −29 inHg (−9.82×10⁴ Pa). In embodiments in which the isolated copolymer is dried under an inert atmosphere, the inert atmosphere may comprise nitrogen, argon, or helium. The drying step may take place in a fluid bed dryer, a tumble dryer, a rotary dryer, a tray dryer, a vacuum tray dryer, a belt dryer, a fluidized bed dryer, a spray dryer, a rolling bed dryer, a conduction dryer, a convection dryer, a dispersion dryer, and the like.

The duration of the drying step can and will vary. In some embodiments, the drying step may proceed for about 18 hours, about 24 hours, about 36 hours, about 48 hours, about 60 hours, about 72 hours, or more than about 72 hours.

In some embodiments, the dried copolymer may be resuspended in water, mixed with a plasticizing solvent, and then re-dried as described above. Suitable plasticizing solvents include toluene, octane, cyclohexane, heptane, benzyl alcohol, and isoamyl alcohol.

### (II) Copolymer of Styrene and Vinylpyridine

Another aspect of the present disclosure encompasses a copolymer of styrene and a vinylpyridine prepared by the processes described above in section (I) that has a content of residual (styrene and vinylpyridine) monomers of less than about 1000 parts per billion (ppb), and wherein the copolymer is produced in a batch of at least one kg. In some embodiments, the content of residual monomers of less than about 900 ppb, less than about 800 ppb, less than about 700 ppb, less than about 600 ppb, less than about 500 ppb, less than about 400 ppb, less than about 300 ppb, less than about 200 ppb, less than about 100 ppb, or less than about 50 ppb. In specific embodiments, the content of residual monomers of less than about 200 ppb. The residual monomer content in the copolymer may be quantitated using a mass spectrometry method. For example the residual levels of styrene and vinylpyridine in the copolymer may be quantitated using a gas chromatography/mass spectrometry (GC/MS) method. The GC/MS method may use isotope dilution calibration. In some embodiments, the residual levels of styrene and vinylpyridine in the copolymer may be quantitated by headspace solid-phase microextraction followed by GC/MS.

The copolymer disclosed herein has an inherent viscosity that ranges from about 1.0 to about 1.6 dL/g. In certain embodiments, the inherent viscosity of the copolymer may range from about 1.0 to about 1.2 dL/g, from about 1.2 to about 1.4 dL/g, or from about 1.4 to about 1.6 dL/g. In specific embodiments, the inherent viscosity of the copolymer may range from about 1.2 to about 1.4 dL/g. The inherent viscosity may be measure in measured in a 0.25% solution of the copolymer at room temperature. The solution of the copolymer may comprise a suitable solvent such as, e.g., dimethylformamide, acetonitrile, dimethyl sulfoxide, tetrahydrofuran, and the like.

In specific embodiments, the copolymer is poly(2-vinylpyridine-co-styrene) in which the residual content of 2-vinylpyridine and styrene is less than about 200 ppb and the copolymer has an inherent viscosity from about 1.2 to about 1.4 dL/g.

### DEFINITIONS

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The term “about,” particularly in reference to a given quantity, is meant to encompass deviations of plus or minus five percent.

The term “residual monomer content” refers to the combined amount of styrene monomers and vinylpryridine monomers.

### EXAMPLES

The following examples describe certain embodiments of the claimed process.

### Example 1: Copolymer Preparation—Sodium Chloride as Coagulation Initiator

A mixture of 33 ml (30 g, 0.29 mol) of styrene and 72 ml (70.3 g, 0.37 mol) of 2-vinylpyridine was washed twice with a total of 67 g of a 5% aqueous solution of sodium hydroxide and then washed three times with 192 mL of deionized water. The treated monomers were then loaded into a 500 mL round bottom flask equipped with mechanical stirring, N₂ inlet, a condenser, and a thermometer. The flask was sealed and continuously purged with N₂ before loading monomers. An emulsifier solution of 1.53 g (38.3 mmol) NaOH, 200 mL water, and 3.08 g (10.9 mmol) oleic acid was prepared and then added to the reaction flask containing the monomers. The emulsifier solution and the monomers were mixed and then an additional 100 mL of water was added to the flask. Under mechanical stirring, the reaction mixture was heated and thermostated at 50-60° C. When the mixture temperature reached about 50° C., an initiator solution of sodium persulfate (1 g) in water (20 mL) was added to the flask over the course of 2-5 minutes. The reaction was maintained overnight.

The resultant emulsion was poured into a saturated NaCl solution (˜270 g) and heated to 65° C. The product then was recovered by hot filtration. The filtered product was re-dispersed in ˜800 mL water, stirred at 60° C. for about 20 min, cooled, and then filtered. The final step was repeated one more time with 600 mL water, stirring at 60° C. for 10 min, cooling, and then filtering. The final product was dried in vacuum oven at 80° C. overnight.

Results. Yield: 80 g, Inherent Viscosity: 1.45 dL/g (0.25 g/100 ml DMF, r.t.), residual monomers, styrene: 43 ppb, 2-vinyl pyridine 34 ppb by GC.

### Example 2: Copolymer Preparation—Acetic Acid as Coagulation Initiator

A mixture of 165 ml (150 g, 1.45 mol) of styrene and 360 ml (352 g, 1.85 mol) of 2-vinylpyridine was washed twice with a total of 320 ml of a 5% aqueous solution of sodium hydroxide and then washed three times with 320 g of deionized water each. The treated monomers were loaded into a 3 L round bottom flask equipped with mechanical stirring, N₂ inlet, a condenser, and a thermometer. The flask had been sealed and continuously purged with N₂ before loading monomers. An emulsifier solution of 7.7 g NaOH, 1000 mL water, and 15.3 g oleic acid was prepared and then added to the reaction flask added to the reaction flask containing the monomers. The emulsifier solution and the monomers were mixed and another 500 mL of water was added to the flask. Under mechanical stirring, the reaction mixture was heated and thermostated at 50-60° C. When the mixture temperature reached about 50° C., an initiator solution of sodium persulfate (5 g) in water (100 mL) was added to the flask over the course of 2-5 minutes. The reaction was maintained overnight.

The resultant emulsion was poured into a 4 L beaker. All the areas of the reaction flask that were in contact with emulsion were rinsed with DI water. A total of about 2400 ml emulsion was collected. With stirring, 8.36 g of acetic acid in 370 mL of water was slowly added into the emulsion at room temperature to form a slurry. The mixture was heated to 80° C. When temperature reached about 78° C., another 1.625 g of acetic acid in 300 mL of water was slowly added into the slurry mixture. The temperature was maintained for 1-15 minutes, the product was recovered by filtration, and further rinsed with 2 L of water. The biscuit of polymers was ground, redispersed in about 3.5 L of water, and stirred at 80° C. for about 15 min. The mixture was cooled, filtered, and rinsed with about 8 L of water. The final product was dried under vacuum at 80° C. for 4 days or less. Results. Yield: 488 g; Inherent Viscosity: 1.15; monomer residuals, styrene, 290 ppb, 2-vinyl pyridine 48 ppb.

Using acetic acid as a coagulation initiator resulted in copolymers with lower inherent viscosities, and its use also required high precision. For example, adding too little resulted in the incomplete coagulation, and adding too much resulted in the formation of sticky material. It was hypothesized that the polymer was sensitive to the organic solvent nature of acetic acid. Accordingly, a different coagulation initiator was sought, as detailed in the following example.

### Example 3: Copolymer Preparation—Sodium Hydrogen Phosphate as Coagulation Initiator

A copolymer of styrene and 2-vinylpyridine was prepared essentially as described above in Example 1, except that an aqueous solution of sodium hydrogen phosphate was used as the coagulation initiator. A one molar equivalent was used with respect to sodium hydroxide. Sodium hydrogen phosphate successfully initiated the coagulation of the polymer without the formation of sticky material. The resultant copolymer was dried in vacuum oven at 80° C. overnight. The inherence viscosity of the copolymer fell within the desired range and the residual content of monomers was below 200 ppb.

### Example 4. Use of Various Surfactants

Polymerization reactions were conducted in the presence of different surfactants. In the examples detailed above, the oleic acid added to the emulsion forms sodium oleate in situ. It was found that lauric acid could be substituted for oleic acid (the resulting polymers had inherent viscosities in the range of 1.3 to 1.4 dL/g). However, the sodium salts of stearic acid and palmitic acid precipitated as the polymerization progressed. It was determined that 3.1 wt % of surfactant with respect to monomer content was optimal. The use of greater quantities of surfactant (4.6 wt % or 6.1 wt %) led to the formation of polymers with lower inherent viscosities.

### Example 5. Use of Unwashed Monomers

Generally, the styrene and 2-vinylpyridine monomers are washed to remove the inhibitor that is added for stabilization. Washing the monomers involves combining them and washing with a 5% sodium hydroxide solution followed by washing three times with water. Because the time and labor involved in this washing process, copolymer was prepared using unwashed monomers. Polymerizations using unwashed monomers provided polymers with inherent viscosities in the range of 1.1 to 1.2 dL/g, whereas polymerizations using washed monomers provided polymers with inherent viscosities in the range of 1.3 to 1.4 dL/g.

Polymerizations were performed using less polymerization initiator to see if the inherent viscosity could be increased in polymers prepared using unwashed monomers. Rather than using 1.0 wt % of initiator, 0.67 wt % of sodium persulfate was used to initiate polymerization of unwashed monomers (with lauric acid as the surfactant). The resulting polymers had inherent viscosities of about 1.3 dL/g. Generally, the polymerization initiator was added over a period of 2-5 minutes. Experiments were performed in which addition times of 15 and 30 minutes were screened. In both cases there was no effect on the inherent viscosities of the resulting polymers.

### Example 6. Drying Step

The temperature and pressure were varied during the drying step to determine the impact on the residual monomer content. The lower the pressure and the higher the temperature during the drying step, the lower the residual monomer content in the polymer. The optimal drying temperature is in the range of 70-80° C., with an upper temperature limit of about 80° C. Drying the polymer in a tray dryer at 80° C. resulted in a powdered product that tends to “melt” into a solid mass. Drying the polymer at 80° C. in a tumble dryer, however, resulted in a product that maintains its powdered form. Pressures of −19 inHg (−6.43×10⁴ Pa) to −29 inHg (−9.82×10⁴ Pa) were tested and better results were obtained at the lower pressures. In most cases the polymer had a residual monomer content of less than about 200 ppb when dried for 48 hours using temperatures near 80° C. and pressures near −29 inHg (−9.82×10⁴ Pa).

What is claimed is:

1. A copolymer of styrene and a vinylpyridine, wherein the copolymer has a residual monomer content of less than about 1000 parts per billion (ppb), and the copolymer is produced in a batch of at least about one kg.

2. The copolymer of claim 1, wherein the vinylpyridine is 2-vinylpyridine, 3-vinylpyridine, or 4-vinylpyridine; the residual monomer content is less than about 500 ppb, less than about 200 ppb, or less than about 100 ppb; and the copolymer is produced in a batch of at least about 10 kg, at least about 100 kg, or at least about 1,000 kg.

3. The copolymer of claim 1, wherein the copolymer has an inherent viscosity of about 1.0 to about 1.6 dL/g when the inherent viscosity is measured in a 0.25% solution of the copolymer in dimethylformamide at room temperature.

4. The copolymer of claim 1, wherein the vinylpyridine is 2-vinylpyridine, the monomer content is less than about 200 ppb, and a 0.25% solution of the copolymer in dimethylformamide has an inherent viscosity of about 1.2 to about 1.4 dL/g at room temperature.

5. A process for preparing a copolymer of styrene and a vinylpyridine having a residual monomer content of less than about 1000 parts per billion (ppb), the process comprising:
a) mixing styrene and vinylpyridine monomers, an aqueous solvent, an alkalizing agent, and a surfactant to form an emulsion;
b) heating the emulsion at a temperature of about 50° C. to about 60° C. in the presence of a polymerization initiator to form the styrene-vinylpyridine copolymer;
c) contacting the emulsion from step (b) with sodium hydrogen phosphate to form a coagulated copolymer; and
d) isolating and drying the coagulated copolymer at a temperature of at least about 60° C. under reduced pressure or an inert atmosphere to produce the copolymer of styrene and a vinylpyridine in which the residual monomer content is less than about 1000 ppb.

6. The process of claim 5, wherein the residual monomer content is less than about 500 ppb, less than about 200 ppb, or less than about 100 ppb.

7. The process of claim 5, wherein the vinylpyridine is 2-vinylpyridine, 3-vinylpyridine, or 4-vinylpyridine.

8. The process of claim 5, wherein the aqueous solvent is water, the alkalizing agent is a hydroxide salt, the surfactant is a salt of oleic or lauric acid, and the polymerization initiator is sodium persulfate.

9. The process of claim 5, wherein sodium hydrogen phosphate at step (c) is an aqueous solution of sodium hydrogen phosphate.

10. The process of claim 9, wherein the emulsion from step (b) is heated to a temperature from about 50° C. to about 55° C. before contact with the aqueous solution of sodium hydrogen phosphate.

11. The process of claim 10, further comprising heating to a temperature from about 50° C. to about 55° C. for at least one hour after contact with the aqueous solution of sodium hydrogen phosphate.

12. The process of claim 5, wherein the temperature of drying at step (d) is from about 70° C. to about 80° C.; the drying at step (d) occurs at a pressure from about −6.77×10⁴ Pa to about −1.02×10⁵ Pa or under a nitrogen, argon, or helium atmosphere; and the drying at step (d) proceeds for at least 24 hours.

13. The process of claim 5, wherein the copolymer is prepared in a batch of at least about 1 kg, at least about 10 kg, at least about 100 kg, or at least about 1,000 kg.

14. The process of claim 5, wherein the vinylpyridine is 2-vinylpyridine, the monomer content is less than about 200 ppb, and a 0.25% solution of the copolymer in dimethylformamide has an inherent viscosity of about 1.2 to about 1.4 dL/g at room temperature.

15. A process for preparing a copolymer of styrene and a vinylpyridine having a residual monomer content of less than about 1000 parts per billion (ppb), the process comprising:
a) adding styrene and vinylpyridine monomers to a mixture comprising an aqueous solvent, an alkalizing agent, a surfactant, and a suspending agent to form a suspension;
b) heating the suspension at a temperature of about 50° C. to about 80° C. in the presence of a free radical initiator to form the styrene-vinylpyridine copolymer; and
c) isolating and drying the styrene-vinylpyridine copolymer at a temperature of at least about 60° C. under reduced pressure or an inert atmosphere to produce the copolymer of styrene and a vinylpyridine in which the residual monomer content is less than about 1000 ppb.

16. The process of claim 15, wherein the residual monomer content is less than about 500 ppb, less than about 200 ppb, or less than about 100 ppb.

17. The process of claim 15, wherein the vinylpyridine is 2-vinylpyridine, 3-vinylpyridine, or 4-vinylpyridine.

18. The process of claim 15, wherein the aqueous solvent is water, the alkalizing agent is a hydroxide salt, the surfactant is a salt of oleic or lauric acid, the suspending agent is carboxymethyl methyl cellulose, and the free radical initiator is t-butyl peroctoate or t-butyl perbenzoate.

19. The process of claim 15, further comprising adding a plasticizing solvent to the suspension before, during, or after step (b), wherein the plasticizing solvent is toluene, octane, cyclohexane, heptane, benzyl alcohol, or isoamyl alcohol.

20. The process of claim 15, wherein the temperature of drying at step (c) is from about 70° C. to about 80° C.; the drying at step (c) occurs at a pressure from about −6.77×10⁴ Pa to about −1.02×10⁵ Pa or under a nitrogen, argon, or helium atmosphere; and the drying at step (c) proceeds for at least 24 hours.

21. The process of claim 15, wherein the copolymer is prepared in a batch of at least about 1 kg, at least about 10 kg, at least about 100 kg, or at least about 1,000 kg.

22. The process of claim 15, wherein the vinylpyridine is 2-vinylpyridine, the monomer content is less than about 200 ppb, and a 0.25% solution of the copolymer in dimethylformamide has an inherent viscosity of about 1.2 to about 1.4 dL/g at room temperature.
